(19) United States
(12) Patent Application Publication
(10) Pub. No.: US 2018/0362042 A1
(43) Pub. Date: Dec. 20, 2018

(54) VEHICLE

(71) Applicant: HONDA MOTOR CO., LTD., Tokyo (JP)

(72) Inventor: Hisashi ISHIKAWA, Saitama (JP)

(73) Assignee: HONDA MOTOR CO., LTD., Tokyo (JP)

(21) Appl. No.: 15/995,365

(22) Filed: Jun. 1, 2018

(30) Foreign Application Priority Data
Jun. 14, 2017 (JP) 2017-117057

(51) Int. Cl. B60W 30/16; B60W 30/18; B60W 20/30; F16H 61/08; F16H 59/60

(52) U.S. Cl. CPC B60W 30/162; B60W 30/18136; B60W 30/18127; B60K 6/485; F16H 61/08; F16H 59/60; B60W 20/30

(57) ABSTRACT

A vehicle which includes an energy storage device, a rotating electric machine, a recognition unit for recognizing an other vehicle in front, a support unit, and a control unit configured to controlling charge and discharge of the rotating electric machine and the energy storage device according to support control of the support unit. When travelling is performed in accordance with support control, and the support unit predicts or detects that the other vehicle is in a near space closer to the vehicle than a space which satisfies the predetermined positional relationship ahead in a travelling direction of the vehicle based on recognized contents of the recognition unit, the control unit sets a regeneration preparation state where an allowable charging electricity amount, by which the energy storage device can be charged by regenerative electric power generated by the rotating electric machine operating as a generator, is increased.

### CROSS-REFERENCE TO RELATED APPLICATION

The present application claims the benefit of priority of Japanese Patent Application No. 2017-117057, filed on Jun. 14, 2017, the content of which is incorporated herein by reference.

### BACKGROUND

### 1. Field of the Invention

The present invention relates to a vehicle.

### 2. Description of the Related Art

In recent years, various driving support devices have been developed and put to practical use to reduce the burden on drivers of vehicles and to avoid accidents. As one of such driving support devices, a device having an adaptive cruise control function (hereinafter referred to as an “ACC function”) is known.

In general, the ACC function is premised on being used when travelling is performed on an expressway where the operation frequency of an accelerator and a brake is relatively low. The driving support device sets a target speed when the driver performs an operation to activate the ACC function and carries out constant speed travelling at the target speed when there is no preceding vehicle. When there is a preceding vehicle, the driving support device controls the driving force and the braking force of the vehicle so as to perform follow-up travelling while a constant inter-vehicle distance (a target inter-vehicle distance) is maintained.

JP-A-2003-025869 discloses a technique where, in a vehicle capable of using at least one of follow-up travelling control included in the ACC function described above and automatic engine brake control to automatically apply engine brake by transmission control of a transmission under travelling conditions requiring engine brake, even when instructions to perform follow-up travelling control is applied, the automatic engine brake control is continued while an inter-vehicle distance is equal to or more than the target inter-vehicle distance, and the automatic engine brake control is stopped when the inter-vehicle distance becomes less than the target inter-vehicle distance. The technique has the idea that it is practically effective that the engine brake can be applied until the inter-vehicle distance reaches the target inter-vehicle distance when travelling is performed on a downhill road requiring engine brake. According to the technique, the follow-up travel control is started while travelling is performed on a downhill road requiring engine brake. However, the automatic engine brake control is continued when the inter-vehicle distance is equal to or more than the target inter-vehicle distance, and thus it is possible to prevent sudden acceleration which occurs when the automatic engine brake control is inactivated while travelling is performed on a downhill road.

In the technique of JP-A-2003-025869 described above, since the automatic engine brake control is performed by the gear change of the transmission, the technique described above cannot be applied to a vehicle such as an electric vehicle having no transmission. However, the electric vehicle can obtain a braking force by causing the electric motor, which is the drive source, to perform regenerative operation. Therefore, when the follow-up travel control is operated while the electric vehicle is travelling on a downhill road, an electric motor is regeneratively operated instead of the automatic engine brake control until the inter-vehicle distance reaches the target inter-vehicle distance and a braking force is obtained, in such a manner that it is possible to prevent a sudden acceleration.

Electric power is generated when the electric motor is regeneratively operated, and thus it is necessary to charge or consume the generated electric power. The electric vehicle is provided with an energy storage device which supplies electric power when the electric motor is subjected to power driving, and thus it is preferable to charge regenerative electric power to the energy storage device, but it cannot be said that the energy storage device can be constantly charged by the regenerative electric power. In other words, when the energy storage device is in a state close to a full charge state, the regenerative electric power cannot be charged in the energy storage device, so that a regenerative operation of the electric motor cannot be performed.

### SUMMARY

An object of the invention is to provide a vehicle capable of obtaining a braking force by fully utilizing a regenerative operation of a rotating electric machine while travelling is performed by driving support.

According to a first aspect of the invention, there is provided a vehicle including: an energy storage device; a rotating electric machine which is connected to a drive wheel and operates as an electric motor by electric power supplied from the energy storage device and which can operate as a generator when the drive wheel is subjected to braking; a recognition unit configured to recognize an other vehicle located in front of the vehicle; a support unit configured to control support driving of the vehicle so that a relative position with respect to the other vehicle recognized by the recognition unit has a predetermined positional relationship and/or constant speed travelling where a travelling speed of the vehicle is equal to or lower than a target speed is performed; and a control unit configured to control charge and discharge of the rotating electric machine and the energy storage device according to support control of the support unit, wherein when the vehicle travels according to support control of the support unit, and the support unit predicts or detects that the other vehicle is in a near space closer to the vehicle than a space which satisfies the predetermined positional relationship ahead in a travelling direction of the vehicle based on recognized contents of the recognition unit, the control unit sets a regeneration preparation state where an allowable charging electricity amount, by which the energy storage device can be charged by regenerative electric power generated by the rotating electric machine operating as a generator, is increased.

According to a second aspect of the invention, in the vehicle according to the first aspect, when the relative position with respect to the other vehicle does not satisfy the predetermined positional relationship after the regeneration preparation state is set, the control unit releases the regeneration preparation state.

According to a third aspect of the invention, in the vehicle according to the second aspect, when the relative position satisfies the predetermined positional relationship again after the relative position with respect to the other vehicle does not satisfy the predetermined relationship, the control unit sets the regeneration preparation state.

According to a fourth aspect of the invention, in the vehicle according to any one of the first to third aspects, the control unit determines whether to set the regeneration preparation state based on a relative speed between the vehicle and the other vehicle.

According to a fifth aspect of the invention, in the vehicle according to any one of the first to third aspects, the support unit determines whether to set the regeneration preparation state based on a distance between the vehicle and the other vehicle.

According to a sixth aspect of the invention, in the vehicle according to any one of the first to fifth aspects, the recognition unit detects a movement or a lighting state of a lamp of the other vehicle related to travelling, and when the support unit predicts or detects that the other vehicle is in the near space based on the information detected by the recognition unit, the control unit sets the regeneration preparation state.

According to a seventh aspect of the invention, in the vehicle according to any one of the first to sixth aspects, the recognition unit detects the movement of the other vehicle related to travelling or the lighting state of the lamp of the other vehicle, and when the vehicle travels at a speed lower than the target speed so that the relative position with respect to the other vehicle positioned in the space ahead in the travelling direction satisfies the predetermined positional relationship, and the support unit predicts or detects that the other vehicle is not in the space based on the information detected by the recognition unit, the control unit releases the regeneration preparation state.

According to the first aspect, when the other vehicle is likely to cut in at a lower speed than the own vehicle travelling speed in front of the own vehicle in the travelling direction during travelling to follow the support control of the support unit, the regeneration preparation state is set and the allowable charging electricity amount by which the energy storage device can be charged is increased. Therefore, thereafter, when the other vehicle actually cuts in at a low speed and the own vehicle needs to decelerate, the energy storage device can be charged by the regenerative electric power generated when the own vehicle operates the rotating electric machine as a generator to obtain the braking force. Also, during follow-up travelling to follow the support control of the support unit, even when the other vehicle travelling ahead is likely to decelerate, the regeneration preparation state is set. Therefore, thereafter, when the other vehicle actually decelerates and the own vehicle also needs to decelerate, the energy storage device can be charged by the regenerative electric power generated when the own vehicle operates the rotating electric machine as a generator to obtain the braking force. In this manner, during travelling with driving support, the braking force can be obtained by fully utilizing the regenerative operation of the rotating electric machine.

According to the second aspect, when the relative position with respect to the other vehicle does not satisfy the predetermined positional relationship, it is possible to prevent unnecessary decrease in the storage amount of the energy storage device by released the regeneration preparation state.

According to the third aspect, when the relative position with respect to the other vehicle does not satisfy the predetermined relationship and then the relative position satisfies the predetermined positional relationship again, the regeneration preparation state is set, and thus it is possible to prepare for the deceleration after the relative position satisfies the predetermined positional relationship.

When the relative speed with respect to the other vehicle is large, a large deceleration is necessary, and thus the amount of the regenerative electric power generated by the rotating electric machine at deceleration regeneration is likely to be large. On the contrary, when the relative speed is small, a large deceleration is not necessary, and thus the amount of the regenerative electric power generated by the rotating electric machine at deceleration regeneration is likely to be small. For this reason, despite the small relative speed, when the regeneration preparation state is set, the storage amount of the energy storage device is unnecessarily reduced. However, according to the fourth, whether to set the regeneration preparation state is determined based on the relative speed, and thus it is possible to prevent unnecessary decrease in the storage amount of the energy storage device.

When the distance to the other vehicle is short, a large deceleration is necessary, and thus the amount of the regenerative electric power generated by the rotating electric machine at deceleration regeneration is likely to be large. On the contrary, when the distance is long, a large deceleration is not necessary, and thus the amount of the regenerative electric power generated by the rotating electric machine at deceleration regeneration is likely to be small. For this reason, despite the long distance, when the regeneration preparation state is set, the storage amount of the energy storage device is unnecessarily reduced. However, according to the fifth aspect, whether to set the regeneration preparation state is determined based on the distance to the other vehicle, it is possible to prevent unnecessary decrease in the storage amount of the energy storage device.

According to the sixth, when a situation that the other vehicle is likely to cut in at a lower speed than the own vehicle travelling speed in front of the own vehicle in the travelling direction during travelling to follow the support control of the support unit is detected from the movement of the other vehicle related to travelling or the lighting state of a lamp of the other vehicle, the regeneration preparation state is set. Therefore, even when the other vehicle actually cuts in at a low speed in front of the own vehicle along the travelling direction and a large deceleration is necessary, it is possible to perform rapid deceleration by the regenerative operation of the rotating electric machine. Further, when a situation that the other vehicle travelling ahead is likely to decelerate during follow-up travelling to follow the support control of the support unit is detected from the movement of the other vehicle related to travelling or the lighting state of a lamp of the other vehicle, the regeneration preparation state is set. Therefore, even when the other vehicle actually decelerates and a large deceleration is necessary, it is possible to perform rapid deceleration by the regenerative operation of the rotating electric machine.

According to the seventh aspect, when a situation that the other vehicle travelling in front of the own vehicle along the travelling direction is not likely to be in a space satisfying the predetermined positional relationship ahead in the travelling direction is detected during follow-up travelling to follow the support control of the support unit, the regeneration preparation state is released. Therefore, when the other vehicle is not in the space, it is possible to prevent unnecessary decrease in the storage amount of the energy storage device.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a block diagram illustrating an internal configuration of a vehicle according to an embodiment:

FIG. 2 is a view illustrating an example of relative positions of an own vehicle with an other vehicle which a relative position with respect to the own vehicle has a predetermined positional relationship;

FIG. 3 is a timing chart in a case where control is performed to change a vehicle speed VP, a transmission gear ratio of a transmission, and the like according to the movement of the other vehicle while the vehicle illustrated in FIG. 1 travels on ACC;

FIG. 4 is a timing chart in a case where control is performed to change the vehicle speed VP, the transmission gear ratio of the transmission, and the like according to the movement of the other vehicle while the vehicle illustrated in FIG. 1 travels on ACC;

FIG. 5A is a view of a first situation where, when the own vehicle travels at a constant speed on the driving lane which is a main road of the expressway, the other vehicle joins the driving lane at a lower speed than the own vehicle in front of the own vehicle from a ramp way. FIG. 5B is a view of a second situation where the own vehicle performs follow-up travelling with respect to the preceding vehicle which is accelerated after joining the main road, and FIG. 5C is a view of a third situation where the preceding vehicle which travels on the main road and is followed by the own vehicle leaves to the ramp way;

FIG. 6 is a timing chart in a case where control is performed to change the vehicle speed VP, the transmission gear ratio of the transmission, and the like according to the movement of the own vehicle with respect to the other vehicle while the vehicle illustrated in FIG. 1 travels on ACC:

FIG. 7 is a timing chart in a case where control is performed to change the vehicle speed VP, the transmission gear ratio of the transmission, and the like according to the movement of the own vehicle with respect to the other vehicle while the vehicle illustrated in FIG. 1 travels on ACC:

FIG. 8A is a view of a fourth situation where the own vehicle travelling at constant speed on a passing lane which is a main road of the expressway joins the driving lane behind the other vehicle travelling the driving lane at a higher speed than the other vehicle, FIG. 8B is a view of a fifth situation where the own vehicle performs follow-up travelling with respect to the preceding vehicle which is accelerated after the own vehicle joins the driving lane, and FIG. 8C is a view of a sixth situation where the own vehicle which travels the driving lane to follow the preceding vehicle obliquely changes the lane to the passing lane:

FIG. 9 is a flowchart which illustrates the flow of processes according to the movement of the other vehicle while the own vehicle travels at a constant speed;

FIG. 10 is a flowchart which illustrates the flow of processes when the own vehicle shifts from constant speed travelling to follow-up travelling; and

FIG. 11 is a flowchart which illustrates the flow of processes when the own vehicle shifts from follow-up travelling to constant speed travelling.

### DETAILED DESCRIPTION OF THE INVENTION

Hereinafter, embodiments of a vehicle according to the invention will be described with reference to the drawings.

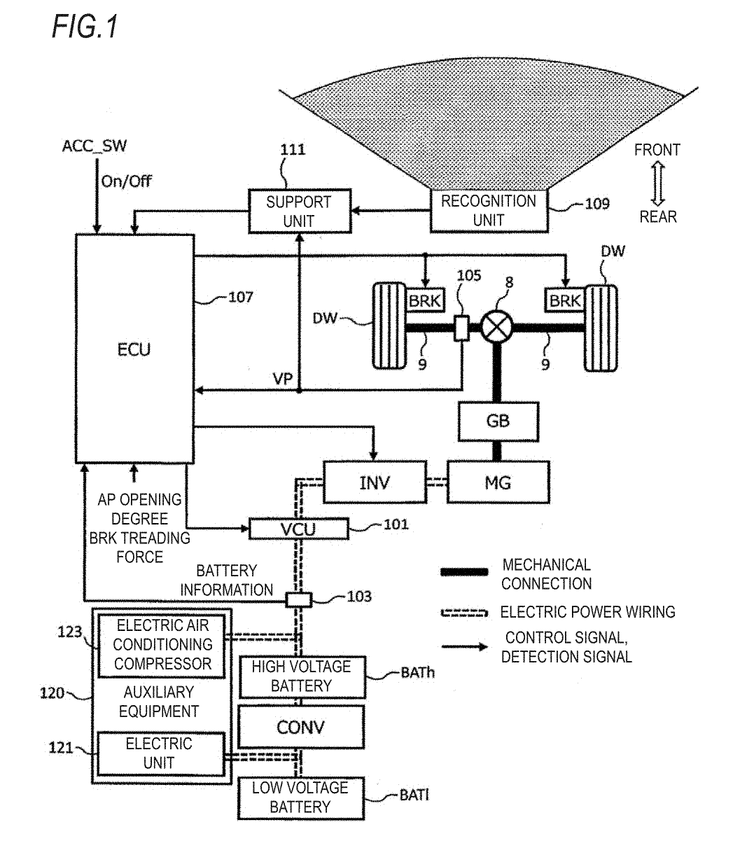

FIG. 1 is a block diagram which illustrates an internal configuration of the vehicle according to the embodiment. In FIG. 1, the thick solid line indicates the mechanical connection, the double dotted line indicates the electric power wiring, and the thin solid line arrow indicates the control signal or the detection signal.

The vehicle illustrated in FIG. 1 includes a motor generator (MG), a gear box (hereinafter simply referred to as a “gear”) GB, a high voltage battery BATh (an energy storage device), a converter CONV, a low voltage battery BATl, a Voltage Control Unit (VCU) 101, an inverter INV, a battery sensor 103, a vehicle speed sensor 105, a brake BRK, an ECU 107, a recognition unit 109, and a support unit 111. The vehicle is a so-called electric vehicle travelling with the power output by the motor generator MG.

Hereinafter, each component of the vehicle illustrated in FIG. 1 will be described.

The motor generator MG generates power for the travelling of vehicle. The power generated by the motor generator MG is transmitted to drive wheels DW via the gear box GB including a variable gear position or a fixed gear position, a differential gear 8, and axle shafts 9. Also, the motor generator MG operates as a generator when braking the vehicle.

The high voltage battery BATh has a plurality of storage cells connected in series and supplies a high voltage of 100 to 200 V, for example. The storage cell is, for example, a lithium ion battery or a nickel hydrogen battery. The converter CONV steps down the output voltage of the high voltage battery BATh. The low voltage battery BATl stores the voltage stepped down by the converter CONV and supplies a constant voltage of 12 V, for example, to an electric unit 121 included in an auxiliary equipment 120. Besides, the high voltage battery BATh is corresponding to the energy storage device, and the energy storage device is not limited to the lithium ion battery and the nickel hydrogen battery.

The VCU 101 boosts the output voltage of the high voltage battery BATh when the motor generator MG operates as an electric motor. Further, the VCU 101 steps down the output voltage of the motor generator MG when a regenerative electric power is captured which is generated by the motor generator MG during braking of the vehicle and converted into direct current. The electric power stepped down by the VCU 101 is charged to the high voltage battery BATh or is supplied to an electric air conditioning compressor 123 included in the auxiliary equipment 120.

The inverter INV converts the DC voltage into an AC voltage and supplies a three-phase current to the motor generator MG. The inverter INV converts the AC voltage which is generated by the motor generator MG during braking of the vehicle into a DC voltage.

The battery sensor 103 detects the output (a terminal voltage, a charge/discharge current) of the high voltage battery BATh. Signals as battery information indicating the terminal voltage, the charging/discharging current, and the like detected by the battery sensor 103 are sent to the ECU 107.

The vehicle speed sensor 105 detects the travelling speed (the vehicle speed VP) of the vehicle. A signal indicating the vehicle speed VP detected by the vehicle speed sensor 105 is sent to the ECU 107.

The brake BRK is a mechanical brake. That is, the brake BRK brakes the vehicle which is controlled by hydraulic pressure or the like according to the operation of the brake pedal by the driver.

The recognition unit 109 recognizes the other vehicle located in front of the own vehicle by using radar units such as an infrared laser radar or a millimeter wave radar, imaging units such as a stereo camera or a monocular camera, or the combination of the radar units and the imaging units. The recognition unit 109 detects the movement of the other vehicle located in front of the own vehicle from the information obtained by the radar units or the imaging units and detects the lighting state of a lamp such as a brake lamp or a direction indicator lamp of the other vehicle.

The support unit 111 performs so-called adaptive cruise control (Adaptive Cruise Control) to support the operation of the own vehicle. The support unit 111 selectively switches between the constant speed travelling control and the inter-vehicle distance control in accordance with the exterior situation recognized by the recognition unit 109. When there is no preceding vehicle, the support unit 111 performs a constant speed travelling control and the vehicle carries out constant speed travelling up to at the target speed by the control. The difference between the vehicle speed and the target speed during constant speed travelling is equal to or less than a predetermined speed. On the contrary, when there is a preceding vehicle, the support unit 111 performs the inter-vehicle distance control and the vehicle performs follow-up travelling while the vehicle maintains a constant inter-vehicle distance (a target inter-vehicle distance) by the control. In the following description, both the constant speed travelling control and the inter-vehicle distance control performed by the support unit 111 are collectively referred to as “ACC”.

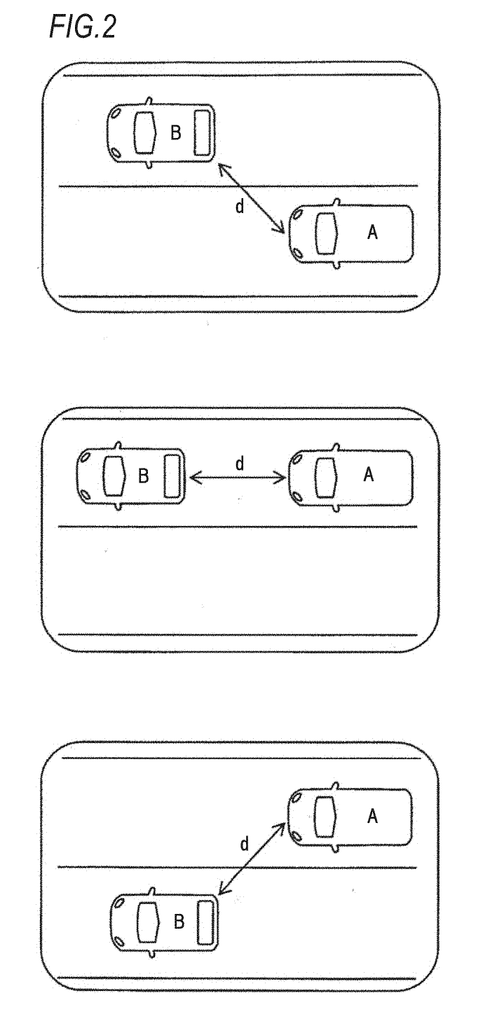

In the above description, the “preceding vehicle” is the other vehicle which is located in a portion in front of the own vehicle recognized by the recognition unit and is predicted that the relative position with respect to the own vehicle has a predetermined positional relationship or has the predetermined positional relationship described above. As illustrated in FIG. 2, the other vehicle B of which the relative position with respect to the own vehicle has a predetermined positional relationship and the own vehicle A travel the same lane or the adjacent lanes in a state where a distance d between both vehicles is substantially constant. As a result, the relative position of the own vehicle A with the other vehicle B satisfies a “predetermined positional relationship”.

The ECU 107 performs the operation control of the motor generator MG by controlling the VCU 101 and the inverter INV and the control of the brake BRK based on an accelerator pedal opening degree (an AP opening degree) in response to an accelerator pedal operation by the driver, a brake pedal treading force (a BRK treading force) according to the operation of the brake pedal by the driver, and the vehicle speed VP obtained from the vehicle speed sensor 105. Based on the battery information obtained from the battery sensor 103, the ECU 107 calculates SOC (State Of Charge: also referred to as remaining capacity) which is a variable expressing the state of charge of the high voltage battery BATh by percentage. When the SOC is 100%, the high voltage battery BATh is in a fully charged state. The ECU 107 sets a target value of SOC (a target SOC) of the high voltage battery BATh.

Further, when a switch ACC_SW for activating ACC by the support unit 111 is in the ON state, whether or not the accelerator pedal is operated by the driver, the ECU 107 performs the operation control of the motor generator MG and the control of the brake BRK in accordance with control contents of ACC by the support unit 111. It should be noted that the switch ACC_SW is turned on by being operated by the driver while the vehicle travels.

The ECU 107 controls setting or releasing of a regeneration preparation state described below. “Regeneration preparation state” is a condition to prepare the high voltage battery BATh to be charged with the regenerative electric power generated when the motor generator MG operates as a generator during braking of the vehicle as much as possible. The ECU 107 set to the regeneration preparation state sets the target SOC of the high voltage battery BATh to a value higher than the value set when the state is not in the regeneration preparation state. However, the increment of the target SOC varies depending on the difference between the target speed at constant speed travelling and the expected vehicle speed during follow-up travelling when constant speed travelling is changed to follow-up travelling. That is, when the difference is large, the increment of the target SOC is large. Also, when the difference is small, the increment of the target SOC is small, and the target SOC at this time is a value close to the value set when the state is not in the regeneration preparation state. Further, when the SOC of the high voltage battery BATh is equal to or greater than the predetermined value, the ECU 107 which sets the state to the regeneration preparation state performs at least one of power transfer from the high voltage battery BATh to the low voltage battery BATl and active power supply to an electric airconditioning compressor 123 included in the auxiliary equipment 120 for cooling the high voltage battery BATh, in such a manner that active discharge of the high voltage battery BATh is performed.

(Travel Control According to Movement of the Other Vehicle when ACC is Activated)

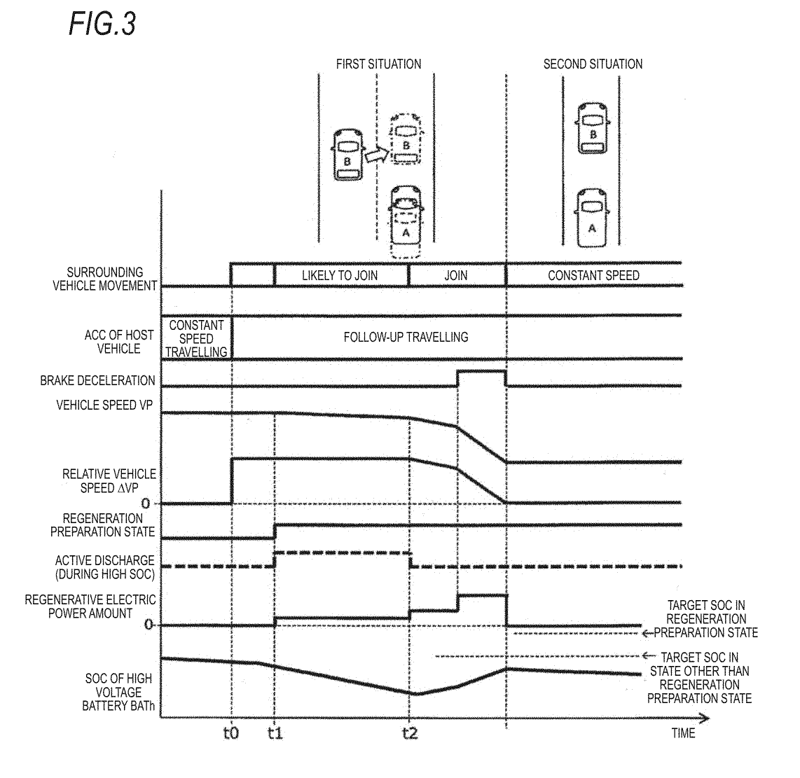

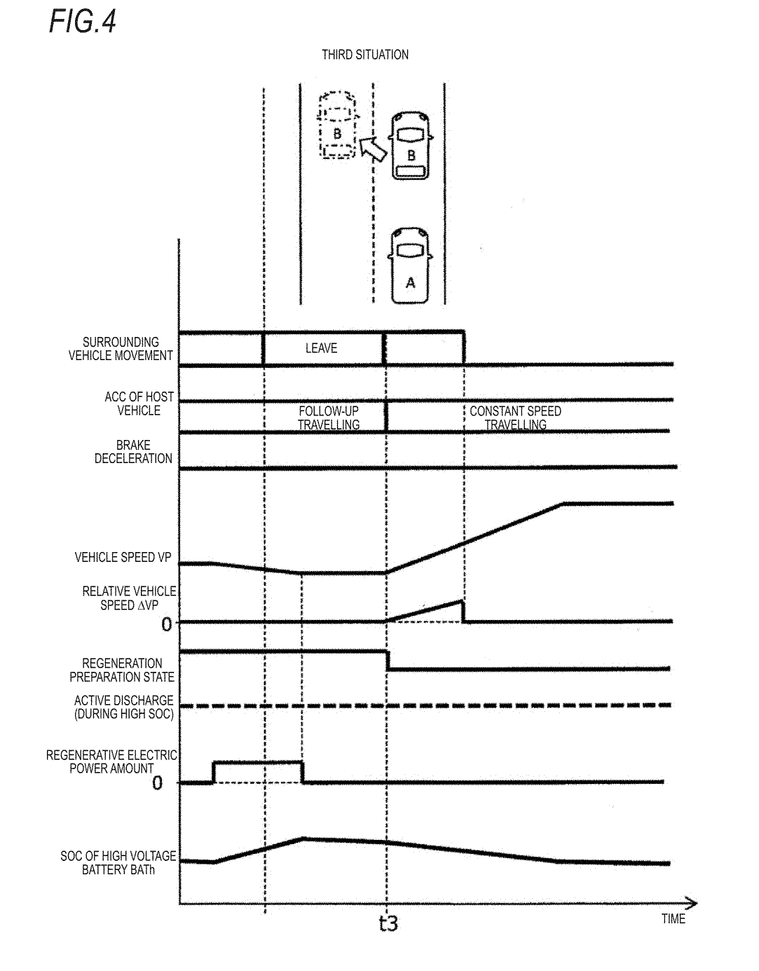

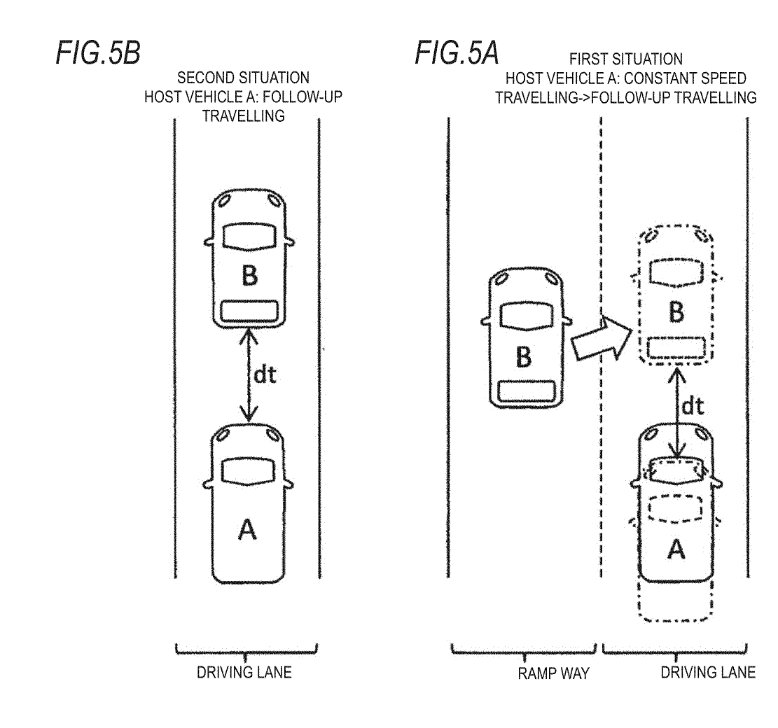

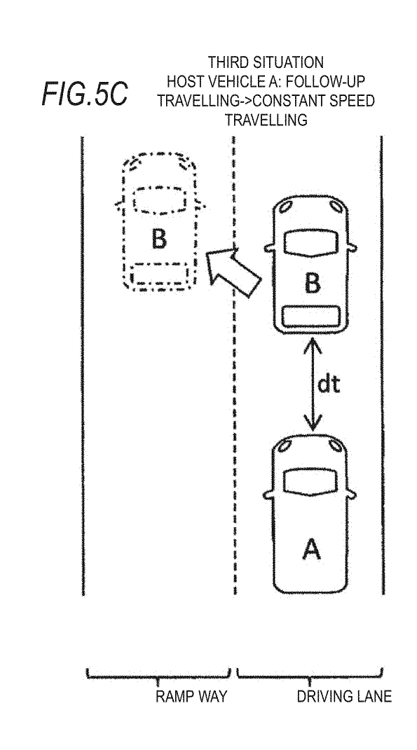

Hereinafter, the control in the own vehicle according to the movement of the other vehicle recognized by the recognition unit 109 when ACC is activated will be described. FIGS. 3 and 4 are timing charts in a case where control is performed to change the vehicle speed VP, and the like according to the movement of the other vehicle while the vehicle illustrated in FIG. 1 travels on ACC. The examples of FIG. 3 include a first situation (see FIG. 5A) where, when the own vehicle travels at a constant speed on the driving lane which is a main road of the expressway, the other vehicle joins the driving lane at a lower speed than the own vehicle in front of the own vehicle from a ramp way and a second situation (see FIG. 5B) where the own vehicle performs follow-up travelling with respect to the preceding vehicle which is accelerated after joining the main road and the example of FIG. 4 includes a third situation (FIG. 5C) where the preceding vehicle which travels on the main road and is followed by the own vehicle leaves to the ramp way.

In the first situation (FIG. 5A) illustrated in FIG. 3, the recognition unit 109 of the own vehicle travelling at constant speed on the driving lane recognizes the other vehicle travelling in the ramp way (time t0) and the support unit 111 predicts that the other vehicle will join in front of the own vehicle from the ramp way to the driving lane (time t1) based on the movement of the other vehicle detected by the recognition unit 109. Further, in the example illustrated in FIG. 3, since the travelling speed of the other vehicle of which joining is expected is slower than that of the own vehicle, when the other vehicle joins the driving lane as expected, the support unit 111 predicts that the other vehicle is in a near space closer to the own vehicle than a space which satisfies the predetermined positional relationship ahead in a travelling direction of the own vehicle. In this case, a distance between the own vehicle and the other vehicle which joins the driving lane becomes shorter than a target inter-vehicle distance dt during follow-up travelling, and thus, the own vehicle is likely to be braked. Therefore, the ECU 107 sets the regeneration preparation state described above and causes the motor generator MG to perform a regenerative operation to slowly decelerate the vehicle. Further, the ECU 107 determines whether to set the regeneration preparation state based on a relative vehicle speed ΔVP (=vehicle speed VP−the other vehicle travelling speed) which is a relative speed between the own vehicle and the other vehicle or a distance between the own vehicle and the other vehicle.

Thereafter, when the support unit 111 determines that the other vehicle has started joining from the ramp way to the driving lane (time t2) based on the movement of the other vehicle detected by the recognition unit 109, in order to adjust the vehicle speed VP to the travelling speed of the other vehicle, the ECU 107 increases the amount of the regenerative electric power generated by the regenerative operation of the motor generator MG to increase the braking force of the vehicle. In the example illustrated in FIG. 3, the difference (the relative vehicle speed) ΔVP between the vehicle speed VP and the travelling speed of the other vehicle cannot be zero only by the braking force due to the regenerative operation of the motor generator MG, and thus the relative vehicle speed ΔVP (=vehicle speed VP−the other vehicle travelling speed) is reduced to zero by applying the mechanical braking force using the brake BRK.

Next, in the second situation (FIG. 5B) illustrated in FIG. 3, both the own vehicle and the other vehicle travel on the same driving lane and the own vehicle travels in accordance with the follow-up travelling control by the support unit 111 so that the inter-vehicle distance related to the other vehicle is maintained by a target inter-vehicle distance dt in order for the relative position with respect to the other vehicle to satisfy the predetermined positional relationship. However, when the other vehicle travels faster than the target vehicle speed during constant speed travelling, follow-up travelling is not performed and constant speed travelling is performed. As a result of the constant speed travelling, when the other vehicle is in a space satisfying the predetermined positional relationship described above ahead along the travelling direction of the own vehicle again, the ECU 107 sets the regeneration preparation state described above.

Next, in the third situation (FIG. 5C) illustrated in FIG. 4, in a case where, when both the own vehicle and the other vehicle travel on the same driving lane and the own vehicle performs follow-up travelling relative to the other vehicle, based on the movement of the other vehicle detected by the recognition unit 109, the other vehicle leaves from the driving lane to the ramp way and the support unit 111 predicts or detects that the other vehicle is not in the space satisfying the predetermined positional relationship described above ahead along the travelling direction of the own vehicle (time t3), the ECU 107 releases the regeneration preparation state and controls the own vehicle to accelerate to the target vehicle speed by the power from the motor generator MG according to the constant speed travelling control by the support unit 111.

(Travelling Control According to Movement of Own Vehicle when ACC is Activated)

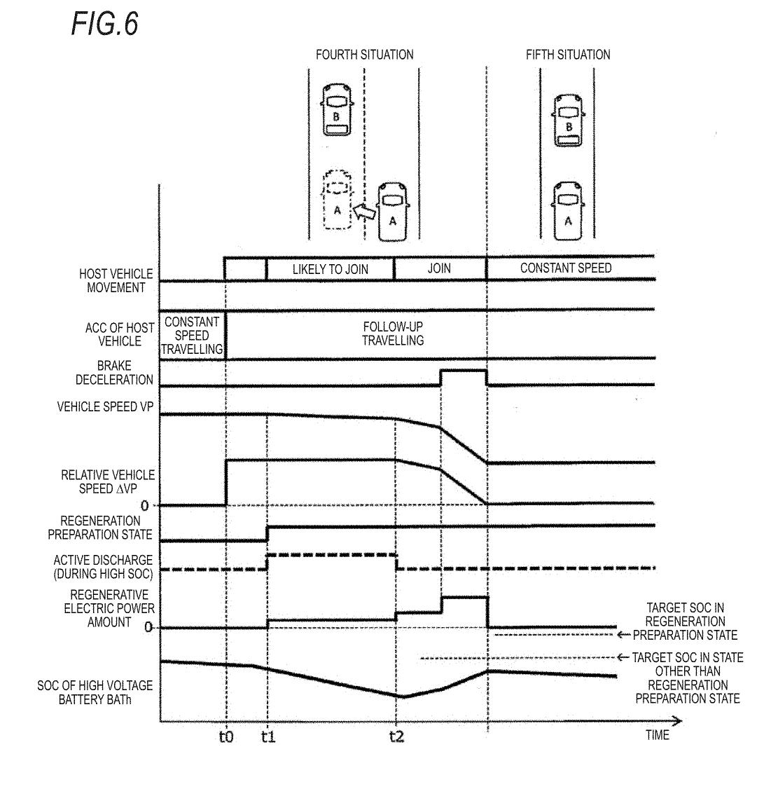

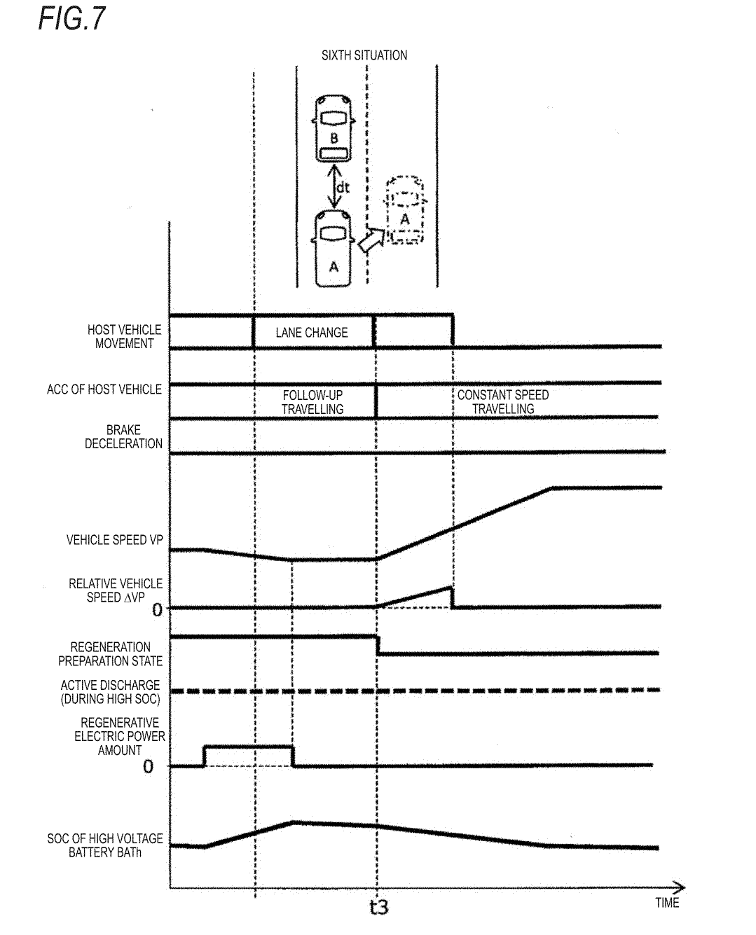

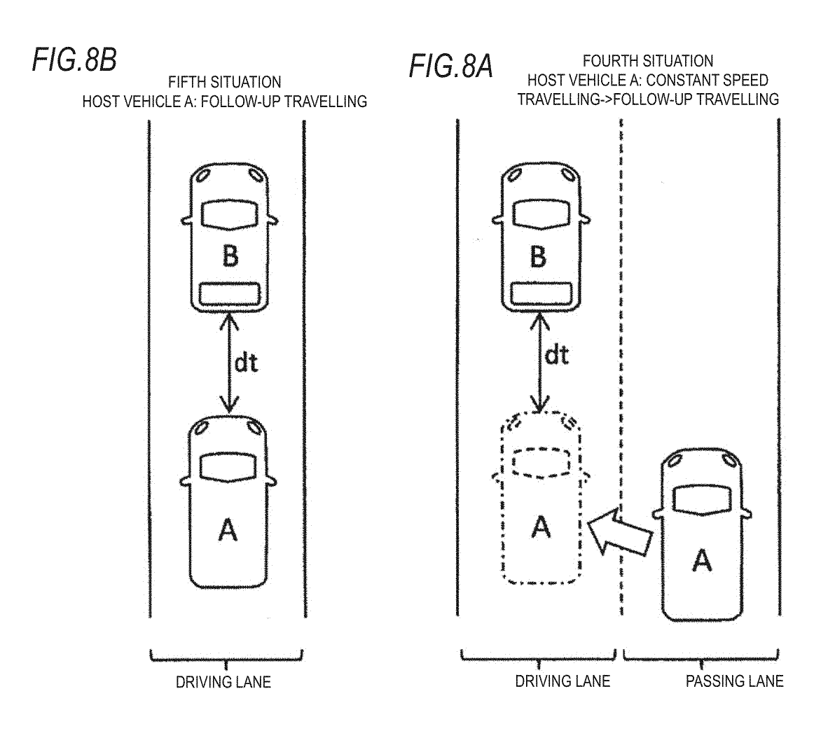

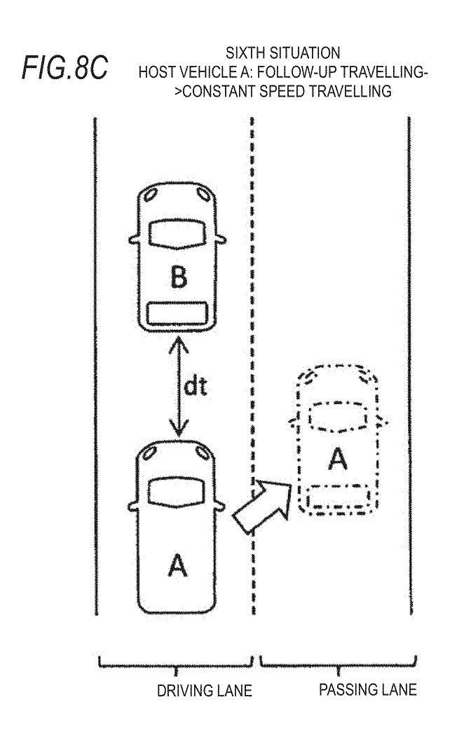

Hereinafter, the control in the own vehicle based on the contents recognized by the recognition unit 109 according to the movement of the own vehicle related to the other vehicle when ACC is activated will be described. FIGS. 6 and 7 are timing charts in a case where control is performed to change the vehicle speed VP, and the like according to the movement of the own vehicle with respect to the other vehicle while the vehicle illustrated in FIG. 1 travels on ACC. The examples illustrated in FIG. 6 includes a fourth situation (FIG. 8A) where the own vehicle travelling at constant speed on a passing lane which is a main road of the expressway joins, by the driver's operation, the driving lane behind the other vehicle travelling the driving lane at a higher speed than the other vehicle and a fifth situation (FIG. 8B) where the own vehicle performs follow-up travelling with respect to the preceding vehicle which is accelerated after the own vehicle joins the driving lane. The example illustrated in FIG. 7 includes a sixth situation (FIG. 8C) where the own vehicle which travels the driving lane to follow the preceding vehicle changes the lane to the passing lane by the driver's operation.

In the fourth situation (FIG. 8A) illustrated in FIG. 6, the recognition unit 109 of the own vehicle travelling at a constant speed on the passing lane recognizes the other vehicle travelling on the driving lane (time t0) and the support unit 111 predicts that the own vehicle will join behind the other vehicle from the passing lane to the driving lane by the driver's operation based on, for example, a change in the relative position with respect to the other vehicle detected by the recognition unit 109 (time t1). Further, in the example shown in FIG. 6, since the travelling speed of the own vehicle is faster than that of the other vehicle, when the own vehicle joins the driving lane as expected, the support unit 111 predicts that the other vehicle is in a near space closer to the own vehicle than the space which satisfies the predetermined positional relationship described above ahead in the travelling direction of the own vehicle. In this case, since the inter-vehicle distance between the own vehicle which joins the driving lane and the other vehicle becomes shorter than the target inter-vehicle distance dt during follow-up travelling, the own vehicle is highly likely to be braked. Therefore, the ECU 107 sets the regeneration preparation state and slowly decelerates the vehicle by causing the motor generator MG to perform a regenerative operation. Further, the ECU 107 determines whether to set the regeneration preparation state based on the relative vehicle speed ΔVP (=vehicle speed VP−the other vehicle travelling speed) which is a relative speed between the own vehicle and the other vehicle or a distance between the own vehicle and the other vehicle.

Thereafter, when the support unit 111 determines that the own vehicle has started joining from the passing lane to the driving lane based on, for example, a change in the relative position with respect to the other vehicle detected by the recognition unit 109 (time t2), in order to adjust the vehicle speed VP to the travelling speed of the other vehicle, the ECU 107 increases the amount of the regenerative electric power generated by the regenerative operation of the motor generator MG to increase the braking force of the vehicle. In the example illustrated in FIG. 6, the difference (the relative vehicle speed) ΔVP between the vehicle speed VP and the travelling speed of the other vehicle cannot be zero only by the braking force due to the regenerative operation of the motor generator MG, and thus the relative vehicle speed ΔVP (=vehicle speed VP−the other vehicle travelling speed) is reduced to zero by applying the mechanical braking force using the brake BRK.

Next, in the fifth situation (FIG. 8B) illustrated in FIG. 6, both the own vehicle and the other vehicle travel on the same driving lane and the own vehicle travels in accordance with the follow-up travelling control by the support unit 111 so that the inter-vehicle distance related to the other vehicle is maintained by a target inter-vehicle distance dt in order for the relative position with respect to the other vehicle to satisfy the predetermined positional relationship. However, when the other vehicle travels faster than the target vehicle speed during constant speed travelling, follow-up travelling is not performed and constant speed travelling is performed. As a result of the constant speed travelling, when the other vehicle is in a space satisfying the predetermined positional relationship described above ahead along the travelling direction of the own vehicle again, the ECU 107 sets the regeneration preparation state described above.

Next, in the sixth situation (FIG. 8C) illustrated in FIG. 7, in a case where, when both the own vehicle and the other vehicle travel on the same driving lane and the own vehicle performs follow-up travelling relative to the other vehicle, the support unit 111 predicts or detects that, based on a change in the relative position with respect to the other vehicle detected by the recognition unit 109, the own vehicle changes the lane to the passing lane by the driver's operation and is not in the space satisfying the predetermined positional relationship described above ahead along the travelling direction of the own vehicle (time t3). The ECU 107 releases the regeneration preparation state and controls the own vehicle to accelerate to the target vehicle speed by the power from the motor generator MG according to the constant speed travelling control by the support unit 111.

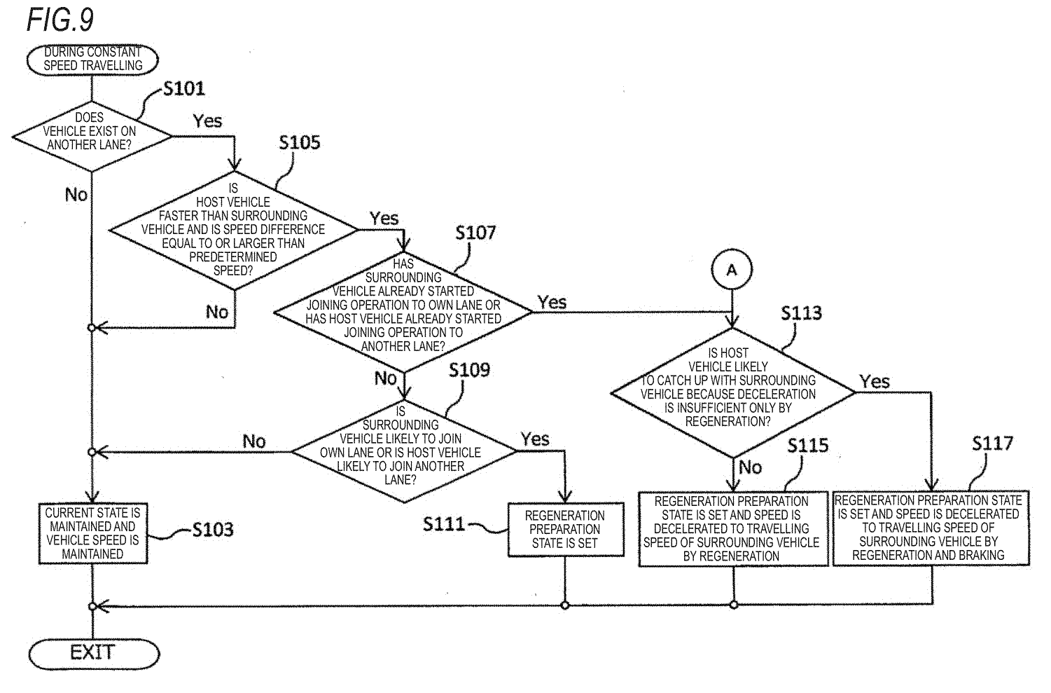

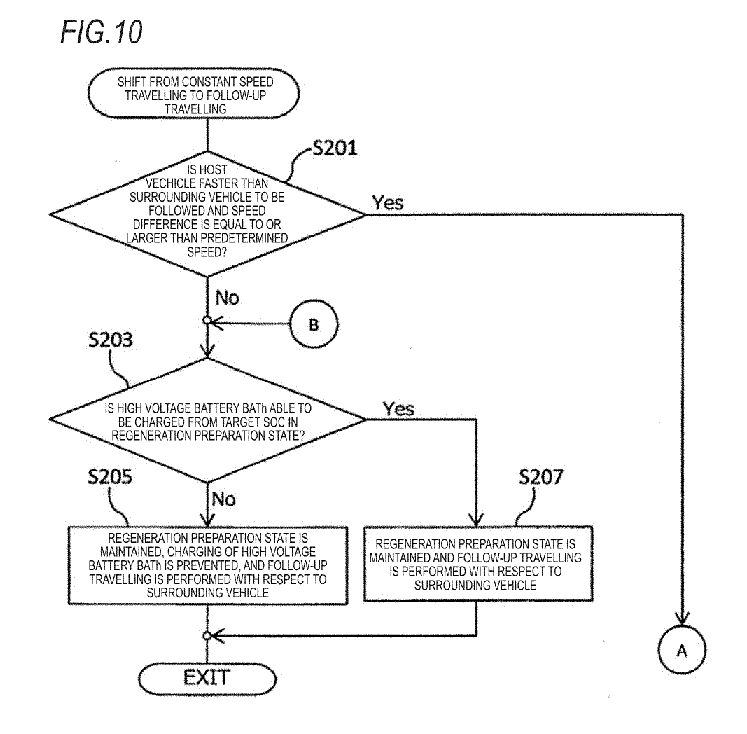

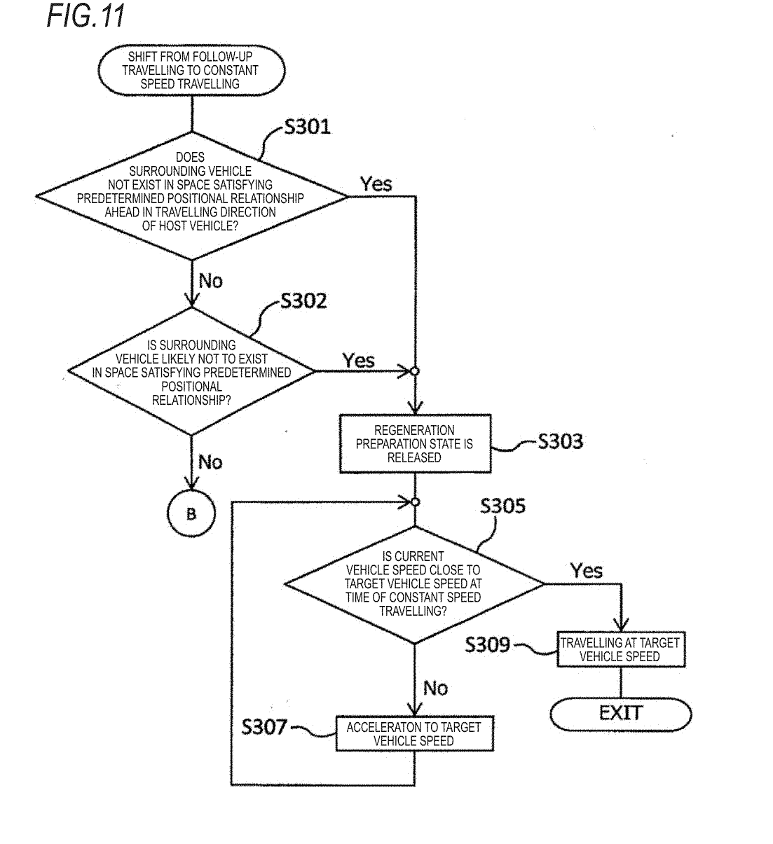

Next, the processes performed by the support unit 111 and the ECU 107 according to the movement of the other vehicle or the own vehicle when ACC is activated will be described in detail with reference to FIGS. 9 to 11. FIG. 9 is a flowchart which illustrates the flow of processes according to the movement of the other vehicle while the own vehicle travels at a constant speed and FIG. 10 is a flowchart which illustrates the flow of processes when the own vehicle shifts from constant speed travelling to follow-up travelling. FIG. 11 is a flowchart which illustrates the flow of processes when the own vehicle shifts from follow-up travelling to constant speed travelling. In the flowcharts of FIGS. 9 to 11, the own vehicle is referred to as “own vehicle” and the other vehicle is referred to as “other vehicle”.

First, the processes according to the movement of the other vehicle while the own vehicle travels at a constant speed will be described. As illustrated in FIG. 9, based on the information recognized by the recognition unit 109, the support unit 111 determines whether or not the other vehicle exists on another lane such as a ramp way (Step S101) and if the other vehicle does not exist, the process proceeds to Step S103, and if there is the other vehicle, the process proceeds to Step S105. In Step S103, the ECU 107 maintains the current state and controls the operation of the motor generator MG to maintain the vehicle speed VP. In Step S105, the support unit 111 determines whether or not the condition that the travelling speed of the other vehicle is faster than the own vehicle and the difference between the travelling speeds of the other vehicle and the own vehicle is equal to or more than a predetermined value is satisfied and if the condition is not satisfied, the process proceeds to Step S103 and if the condition is satisfied, the process proceeds to Step S107.

In Step S107, the support unit 111 determines whether or not the other vehicle has already started a joining operation to the own lane on which the own vehicle travels or the own vehicle has already started a joining operation to another lane on which the other vehicle travels and if the joining operation has not been started, the process proceeds to Step S109 and if the joining operation has been started, the process proceeds to Step S113. In Step S109, the support unit 111 determines whether or not the other vehicle is likely to join the own lane on which the own vehicle travels or the own vehicle is likely to join another lane on which the other vehicle travels and if it is determined that the vehicle is not likely to join, the process proceeds to Step S103 and if it is predicted that the vehicle is likely to join, that is, the vehicle will join, the process proceeds to Step S11. The determination of whether or not the other vehicle or the own vehicle is likely to join is made based on the distance between the own vehicle and the other vehicle. The support unit 111 determines that, when the above distance becomes short, the vehicle is likely to join. In step S111, the ECU 107 sets the regeneration preparation state.

In Step S113, the support unit 111 determines whether or not the deceleration is insufficient only by the regenerative operation of the motor generator MG and the own vehicle is likely to catch up with the other vehicle and if the own vehicle is not likely to catch up with the other vehicle, the process proceeds to Step S115 and if the own vehicle is likely to catch up, the process proceeds to Step S117. The support unit 111 determines that the own vehicle is likely to catch up with the other vehicle if the constant speed difference between the own vehicle and the other vehicle is equal to or larger than a predetermined value and determines that it is not likely to catch up if the difference is less than the predetermined value. In step S115, the ECU 107 sets the regeneration preparation state and controls so that the motor generator MG performs the regenerative operation and the brake BRK operates. As a result, the own vehicle decelerates to the travelling speed of the other vehicle.

Next, the processes of when the own vehicle shifts from constant speed travelling to follow-up travelling will be described. As illustrated in FIG. 10, the support unit 111 determines whether or not the condition that the travelling speed of the other vehicle to be followed by the own vehicle is faster than the own vehicle and the travelling speed difference between the other vehicle and the own vehicle is equal to or larger than a predetermined value is satisfied (Step S201) and if the condition is not satisfied, the process proceeds to Step S203 and if the condition is satisfied, the process proceeds to Step S113 illustrated in FIG. 9. In Step S203, the support unit 111 determines whether or not the high voltage battery BATh is in a chargeable state from the relationship between the target SOC set in the regeneration preparation state and the current SOC of the high voltage battery BATh and if it is not in a chargeable state, the process proceeds to Step S205 and if it is in a chargeable state, the process proceeds to Step S207.

In step S205, the ECU 107 maintains the regeneration preparation state, prevents charging the high voltage battery BATh. and controls the operation of the motor generator MG so as to follow the other vehicle. In step S207, the ECU 107 maintains the regeneration preparation state, and controls the operation of the motor generator MG so as to follow the other vehicle.

Next, the processes of when the own vehicle shifts from follow-up travel to constant speed travelling will be described. As illustrated in FIG. 11, the support unit 111 determines whether or not the other vehicle travelling in front of the own vehicle no longer exists in the space satisfying the predetermined positional relationship described above ahead the own vehicle in the travelling direction (step S301) and if the other vehicle exists, the process proceeds to Step S302 and if the other vehicle does not exist, the process proceeds to Step S303. In step S302, it is determined whether or not the other vehicle is likely not to exist in the space and if it is determined that the other vehicle is likely to exist, the process proceeds to Step S203 illustrated in FIG. 10 and if it is not likely to exist, that is, it is predicted that the other vehicle is likely not to exist, the process proceeds to Step S303.

In Step S303, the ECU 107 sets the regeneration preparation state. Next, the support unit 111 determines whether or not the current vehicle speed VP of the own vehicle is close to the target vehicle speed during constant speed travelling (Step S305) and if the vehicle speed VP is not close to the target vehicle speed, the process proceeds to Step S307 and if it is close to each other, the process proceeds to Step S309. In Step S307, the ECU 107 controls the operation of the motor generator MG so as to accelerate to the target vehicle speed during constant speed travelling. On the contrary, in step S309, the ECU 107 controls the operation of the motor generator MG so as to travel at the target vehicle speed at the time of constant speed travelling.

As described above, according to the embodiment, when the other vehicle is likely to cut in at a low speed in front of the own vehicle in the travelling direction during constant speed travelling, the regeneration preparation state is set and the allowable charging electricity amount by which the high voltage battery BATh can be charged is increased. Therefore, thereafter, when the other vehicle actually cuts in at a low speed and the own vehicle needs to decelerate, the high voltage battery BATh can be charged the regenerative electric power generated when the own vehicle operates the motor generator MG as a generator to obtain the braking force. Also, during follow-up travelling to follow the support control of the support unit 111, even when the other vehicle travelling ahead is likely to decelerate, the regeneration preparation state may be set. In this manner, during travelling with driving support, the braking force can be obtained by fully utilizing the regenerative operation of the motor generator MG.

When the relative position with respect to the other vehicle does not satisfy the predetermined positional relationship, it is possible to prevent unnecessary decrease in the SOC of the high voltage battery BATh by released the regeneration preparation state.

When the relative position with respect to the other vehicle does not satisfy the predetermined relationship and then the relative position satisfies the predetermined positional relationship again, the regeneration preparation state is set, and thus it is possible to prepare for the deceleration after the relative position satisfies the predetermined positional relationship.

When the relative speed with respect to the other vehicle is large, a large deceleration is necessary, and thus the amount of the regenerative electric power generated by the motor generator MG at deceleration regeneration is likely to be large. On the contrary, when the relative speed is small, a large deceleration is not necessary, and thus the amount of the regenerative electric power generated by the motor generator MG at deceleration regeneration is likely to be small. For this reason, despite the small relative speed, when the regeneration preparation state is set, the SOC of the high voltage battery BATh is unnecessarily reduced. In the embodiment, whether to set the regeneration preparation state is determined based on the relative speed, and thus it is possible to prevent unnecessary decrease in the SOC of the high voltage battery BATh.

When the distance to the other vehicle is short, a large deceleration is necessary, and thus the amount of the regenerative electric power generated by the motor generator MG at deceleration regeneration is likely to be large. On the contrary, when the distance is long, a large deceleration is not necessary, and thus the amount of the regenerative electric power generated by the motor generator MG at deceleration regeneration is likely to be small. For this reason, despite the long distance, when the regeneration preparation state is set, the SOC of the high voltage battery BATh is unnecessarily reduced. In the embodiment, whether to set the regeneration preparation state is determined based on the distance to the other vehicle, it is possible to prevent unnecessary decrease in the SOC of the high voltage battery BATh.

When a situation that the other vehicle is likely to cut in at a low speed in front of the own vehicle in the travelling direction during constant speed travelling is detected from the movement of the other vehicle related to travelling or the lighting state of the lamp of the other vehicle, the regeneration preparation state is set. Therefore, even when the other vehicle actually cuts in at a low speed in front of the own vehicle along the travelling direction and a large deceleration is necessary, it is possible to perform rapid deceleration by the regenerative operation of the motor generator MG. Further, when a situation that the other vehicle travelling ahead is likely to decelerate during follow-up travelling is detected from the movement of the other vehicle related to travelling or the lighting state of the lamp of the other vehicle, the regeneration preparation state is set. Therefore, even when the other vehicle actually decelerates and a large deceleration is necessary, it is possible to perform rapid deceleration by the regenerative operation of the motor generator MG.

When a situation that the other vehicle travelling in front of the own vehicle in the travelling direction is not likely to be in a space satisfying the predetermined positional relationship ahead in the travelling direction of the own vehicle is detected during follow-up travelling, the regeneration preparation state is released. Therefore, when the other vehicle is not in the space, it is possible to prevent unnecessary decrease in the SOC of the high voltage battery BATh.

It is to be noted that the present invention is not limited to the embodiment described above, but may be appropriately modified, improved, and the like. For example, the vehicle described above is a 1 MOT type electric vehicle (EV), but the vehicle may be a hybrid electric vehicle (HEV) or a fuel cell electric vehicle (FCEV) as long as the vehicle includes at least one motor generator as a power source and a battery that can be charged by electric power obtained at deceleration regeneration.

What is claimed is:

1. A vehicle comprising:
an energy storage device;
a rotating electric machine which is connected to a drive wheel and operates as an electric motor by electric power supplied from the energy storage device and which can operate as a generator when the drive wheel is subjected to braking;
a recognition unit configured to recognize an other vehicle located in front of the vehicle;
a support unit configured to control support driving of the vehicle so that a relative position with respect to the other vehicle recognized by the recognition unit has a predetermined positional relationship and/or constant speed travelling where a travelling speed of the vehicle is equal to or lower than a target speed is performed; and
a control unit configured to control charge and discharge of the rotating electric machine and the energy storage device according to support control of the support unit, wherein
when the vehicle travels according to support control of the support unit, and the support unit predicts or detects that the other vehicle is in a near space closer to the vehicle than a space which satisfies the predetermined positional relationship ahead in a travelling direction of the vehicle based on recognized contents of the recognition unit, the control unit sets a regeneration preparation state where an allowable charging electricity amount, by which the energy storage device can be charged by regenerative electric power generated by the rotating electric machine operating as a generator, is increased.

2. The vehicle according to claim 1, wherein
when the relative position with respect to the other vehicle does not satisfy the predetermined positional relationship after the regeneration preparation state is set, the control unit releases the regeneration preparation state.

3. The vehicle according to claim 2, wherein
when the relative position satisfies the predetermined positional relationship again after the relative position with respect to the other vehicle does not satisfy the predetermined relationship, the control unit sets the regeneration preparation state.

4. The vehicle according to claim 1, wherein
the control unit determines whether to set the regeneration preparation state based on a relative speed between the vehicle and the other vehicle.

5. The vehicle according to claim 1, wherein
the support unit determines whether to set the regeneration preparation state based on a distance between the vehicle and the other vehicle.

6. The vehicle according to claim 1, wherein:
the recognition unit detects a movement of the other vehicle related to travelling or a lighting state of a lamp of the other vehicle; and
when the support unit predicts or detects that the other vehicle is in the near space based on information detected by the recognition unit, the control unit sets the regeneration preparation state.

7. The vehicle according to claim 1, wherein:
the recognition unit detects the movement of the other vehicle related to travelling or the lighting state of the lamp of the other vehicle; and
when the vehicle travels at a speed lower than the target speed so that the relative position with respect to the other vehicle positioned in the space ahead in the travelling direction satisfies the predetermined positional relationship, and the support unit predicts or detects that the other vehicle is not in the space based on the information detected by the recognition unit, the control unit releases the regeneration preparation state.
